(19) United States
(12) Patent Application Publication
(10) Pub. No.: US 2026/0161337 A1
(43) Pub. Date: Jun. 11, 2026

(54) INFORMATION PROCESSING SYSTEM, INFORMATION PROCESSING APPARATUS, AND STORAGE MEDIUM

(71) Applicant: Konica Minolta, Inc., Tokyo (JP)

(72) Inventor: Daiki SATO, Tokyo (JP)

(21) Appl. No.: 19/181,430

(22) Filed: Apr. 17, 2025

(30) Foreign Application Priority Data
Apr. 22, 2024 (JP) 2024-069167

(51) Int. Cl. G06F 3/12

(52) U.S. Cl. CPC G06F 3/1273; G06F 3/1203; G06F 3/121

(57) ABSTRACT

An information processing system includes a printer, a display apparatus, and a hardware processor. The hardware processor, in response to an operator instructing the printer to perform printing suspension, stores a printing suspension event indicating the printing suspension in a storage as a log, allows the operator to input a printing suspension detail for the printing suspension event, and causes the display apparatus to display the input printing suspension detail and a printing suspension time length in the printing suspension event.

### CROSS-REFERENCE TO RELATED APPLICATIONS

The entire disclosure of Japanese Patent Application No. 2024-069167, filed on Apr. 22, 2024, is incorporated herein by reference in its entirety.

### BACKGROUND OF THE INVENTION

### Technical Field

The present invention relates to an information processing system, an information processing apparatus, and a storage medium.

### Description of Related Art

When print products are produced by a printer, printing may be suspended for some content. For example, a technology has been disclosed in which a log including information related to suspension of printing is obtained from an image forming apparatus (printer), the information related to the suspension is aggregated for each suspension factor, and the information related to the suspension aggregated for each suspension factor is output (see Japanese Unexamined Patent Publication No. 2023-155923). This image forming apparatus detects a malfunction in the image forming apparatus and records information on the detected malfunction. Here, the malfunction detected by the image forming apparatus includes out-of-sheet, sheet jam, tray full, out-of-toner, and the like.

### SUMMARY OF THE INVENTION

However, the technology described in Japanese Unexamined Patent Publication No. 2023-155923 is to record information on suspension of printing about a malfunction detected by the image forming apparatus (printer) itself. In a printer, printing is suspended not only when the printer detects a malfunction but also when an operator of the printer manually instructs the printer to suspend printing. For example, when the operator visually checks a print product and finds an image quality abnormality (image error), the operator instructs the printer to suspend printing. In a case where printing is suspended by an operator's instruction, no log of a malfunction detection is left in the printer. In this case, since a situation in which printing is suspended in the printer is unknown, there is a problem in that analysis or a measure against suspension of printing cannot be performed.

The present invention has been made in view of the above-described problems in the conventional technology, and an object of the present invention is to provide information on printing suspension ordered manually.

To achieve at least one of the abovementioned objects, according to an aspect of the present invention, an information processing system reflecting one aspect of the present invention includes:
a printer;
a display apparatus; and
a hardware processor that
   in response to an operator instructing the printer to perform printing suspension, stores a printing suspension event indicating the printing suspension in a storage as a log,
   allows the operator to input a printing suspension detail for the printing suspension event, and
   causes the display apparatus to display the input printing suspension detail and a printing suspension time length in the printing suspension event.

According to an aspect of the present invention, an information processing apparatus reflecting one aspect of the present invention includes a hardware processor that
obtains, as a log, a printing suspension event indicating printing suspension that an operator has instructed a printer to perform, from the printer,
allows the operator to input a printing suspension detail for the printing suspension event from a display apparatus, and
causes the display apparatus to display the input printing suspension detail and a printing suspension time length in the printing suspension event.

According to an aspect of the present invention, a storage medium reflecting one aspect of the present invention stores a program causing a computer to:
obtain, as a log, a printing suspension event indicating printing suspension that an operator has instructed a printer to perform, from the printer;
allow the operator to input a printing suspension detail for the printing suspension event from a display apparatus; and
cause the display apparatus to display the input printing suspension detail and a printing suspension time length in the printing suspension event.

### BRIEF DESCRIPTION OF THE DRAWINGS

The advantages and features provided by one or more embodiments of the invention will become more fully understood from the detailed description given hereinafter and the appended drawings which are given by way of illustration only, and thus are not intended as a definition of the limits of the present invention, and wherein:

FIG. 1 is a system configuration diagram of an information processing system in a first embodiment of the present invention;

FIG. 2 is a block diagram illustrating a functional configuration of a printer;

FIG. 3 illustrates an example of the data structure of a log management table of the printer;

FIG. 4 is a block diagram illustrating a functional configuration of an information processing apparatus;

FIG. 5 illustrates an example of the data structure of a log management table of the information processing apparatus;

FIG. 6 is a block diagram illustrating a functional configuration of a display apparatus;

FIG. 7 is a flowchart illustrating a first manual suspension recording process that is performed in the printer;

FIG. 8 illustrates an example of a printing suspension detail input screen that is displayed on a display part of the printer;

FIG. 9 is a flowchart illustrating a first printing suspension information management process that is performed in the information processing apparatus;

FIG. 10 is a flowchart illustrating a first printing suspension information browsing process that is performed in the display apparatus;

FIG. 11 illustrates an example of a manual suspension log display screen that is displayed on a display part of the display apparatus;

FIG. 12 illustrates an example of the data structure of a log management table of the printer according to a second embodiment of the present invention;

FIG. 13 is a flowchart illustrating a second manual suspension recording process that is performed in the printer;

FIG. 14 is a flowchart illustrating a second printing suspension information management process that is performed in the information processing apparatus;

FIG. 15 is a flowchart illustrating a second printing suspension information browsing process that is performed in the display apparatus; and

FIG. 16 illustrates an example of the manual suspension log display screen that is displayed on the display part of the display apparatus.

### DETAILED DESCRIPTION

Hereinafter, embodiments of the present invention will be described with reference to the drawings. The advantages and features provided by the embodiments will be understood from the following detailed description and the drawings. However, the scope of the present invention is not limited to the embodiments disclosed below or the examples illustrated in the drawings.

### First Embodiment

First, a first embodiment of the present invention will be described.

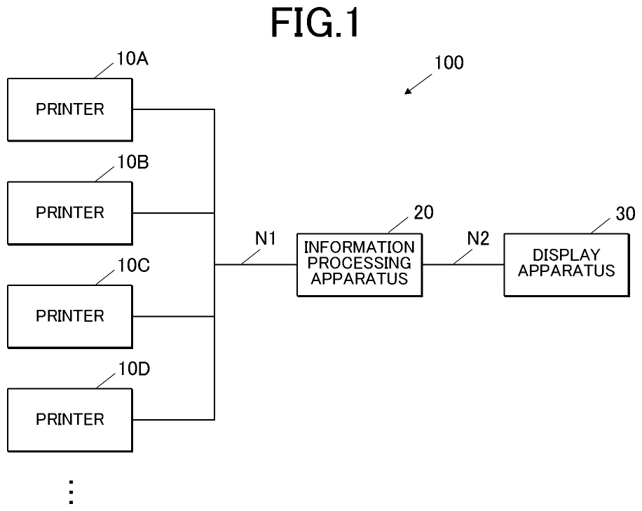

FIG. 1 illustrates a system configuration of an information processing system 100 according to the first embodiment. As illustrated in FIG. 1, the information processing system 100 includes printers 10A, 10B, 10C, 10D, . . . , an information processing apparatus 20, and a display apparatus 30. Each of the printers 10A, 10B, 10C, 10D, . . . and the information processing apparatus 20 are data-communicably connected to each other via a communication network N1. The information processing apparatus 20 and the display apparatus 30 are data-communicably connected to each other via a communication network N2. Examples of the communication networks N1 and N2 include local area network (LAN), wide area network (WAN), the Internet, and the like. Hereinafter, when the printers 10A, 10B, 10C, 10D, . . . are not particularly distinguished, they are referred to as the “printer 10”. The number of printers 10 and the number of display apparatuses 30 are not limited.

Each printer 10 has a printing function to print an image on a printing medium. The printer 10 may be a multifunction peripheral (MFP), a production printer, a home printer, or the like. Furthermore, examples of the printing medium include a sheet, a film, and cloth. Here, a case in which a sheet is used as the printing medium will be described as an example. The printer 10 saves a log related to printing suspension based on an operator's operation instruction.

The information processing apparatus 20 periodically accesses each printer 10 and obtains a log related to printing suspension based on an operator's operation instruction from each printer 10. The information processing apparatus 20 analyzes the obtained log and calculates a printing suspension time length for each printing suspension event. The information processing apparatus 20 may be a cloud server constructed in a cloud environment.

The display apparatus 30 is a device for browsing used by a user (operator). The display apparatus 30 accesses the information processing apparatus 20 via a web browser. The display apparatus 30 obtains information on the printing suspension provided by the information processing apparatus 20, and displays the obtained information on its screen.

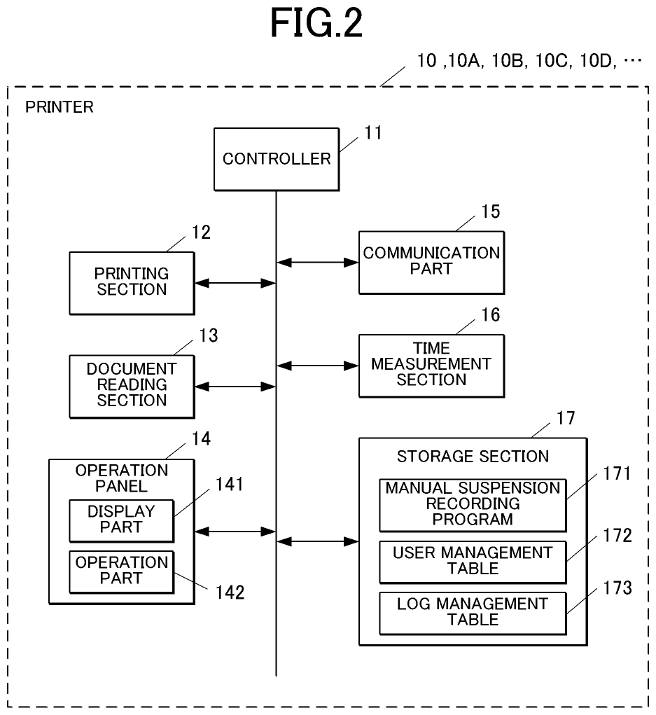

FIG. 2 is a block diagram illustrating a functional configuration of the printer 10. As illustrated in FIG. 2, the printer 10 includes a controller 11 (hardware processor), a printing section 12, a document reading section 13, an operation panel 14, a communication part 15, a time measurement section 16, a storage section 17 (storage), and the like. The components constituting the printer 10 are connected by a bus.

The controller 11 includes a central processing unit (CPU), a random access memory (RAM), and the like. The controller 11 comprehensively controls the operation of each component of the printer 10. Specifically, the CPU reads various programs stored in the storage section 17, and loads the read programs to the RAM. The CPU performs various kinds of processing in cooperation with the programs.

The printing section 12 prints an image on a sheet based on image data received from an external apparatus or image data obtained by reading an image from a document. The printing section 12 is, for example, a color printing section with an electrophotographic method. In this case, the printing section 12 includes photosensitive drums, charging sections, exposure sections, and developing sections for colors of cyan, magenta, yellow, and black. The printing section 12 includes a transfer belt and a fixing section. The charging section corresponding to each color charges the photosensitive drum corresponding to each color. The exposure section corresponding to each color exposes and scans the surface of the photosensitive drum corresponding to each color based on image data corresponding to each color. The developing section corresponding to each color causes toner to adhere to the photosensitive drum corresponding to each color to form a toner image. The toner images formed on the photosensitive drums corresponding to the respective colors are sequentially transferred onto the transfer belt (primary transfer). The color toner image on the transfer belt is transferred onto a sheet (secondary transfer). The fixing section fixes the color toner image on the sheet.

The document reading section 13 reads an image of a document and outputs the obtained image data to the controller 11. The document reading section 13 includes an auto document feeder (ADF), a scanner, and the like.

The operation panel 14 includes a display part 141 and an operation part 142.

The display part 141 is constituted by a liquid crystal display (LCD) or the like. The display part 141 displays various screens in accordance with instructions of display signals input from the controller 11.

The operation part 142 receives an operation input by a user. The operation part 142 outputs, to the controller 11, an operation signal based on the user operation. The operation part 142 includes hard keys and a touch screen. The hard keys are arranged around the screen of the display part 141. The touch screen is integrally formed with the screen of the display part 141.

The communication part 15 includes a network interface and the like. The communication part 15 performs data transmission and reception with an external apparatus connected via the communication network N1.

The time measurement section 16 includes a time measurement circuit (real time clock (RTC)). The time measurement section 16 measures the current date and time with the time measurement circuit, and outputs the current date and time to the controller 11.

The storage section 17 includes a hard disk drive (HDD), a solid state drive (SSD), a nonvolatile semiconductor memory, and/or the like. The storage section 17 stores various programs, various types of data required for executing the programs, and the like. For example, the storage section 17 stores a manual suspension recording program 171, a user management table 172, a log management table 173, and the like.

The manual suspension recording program 171 is a program for recording, in the printer 10, a log related to printing suspension based on an operator's operation instruction.

The user management table 172 is a table for managing users who use the information processing system 100. In the user management table 172, a user ID, a password, and the like are associated with each user. Note that it is sufficient that a user(s) who uses the own apparatus (printer 10) is registered in the user management table 172.

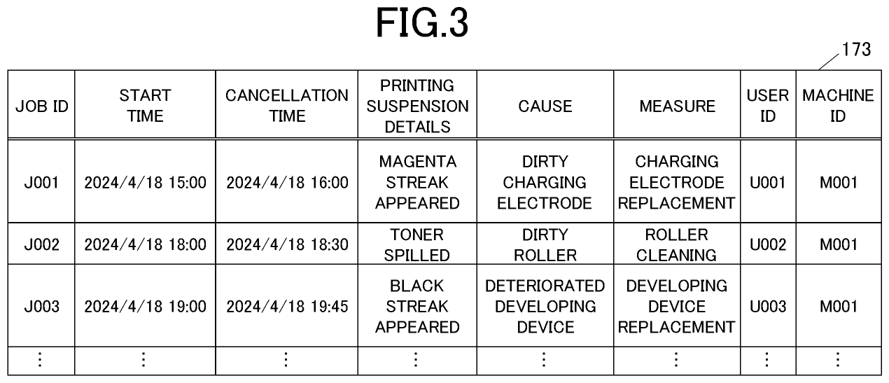

The log management table 173 is a table for managing logs of printing suspension based on manual operation instructions generated in the printer 10. FIG. 3 illustrates an example of the data structure of the log management table 173. In the log management table 173, for each printing suspension event, a job ID, a start time, a cancellation time, printing suspension details (i.e., reason for printing suspension), a cause, a measure, a user ID, and a machine ID are associated.

The job ID is identification information on a job that was being performed by the printer 10 when printing suspension was ordered.

The start time is a time (date and time) when printing suspension was started.

The cancellation time is a time (date and time) when the printing suspension was cancelled.

The printing suspension details are details of an image error (error related to an image) that led to the printing suspension ordered by the operator. The printing suspension details may be a type of malfunction that appears on an image. Examples of the printing suspension details include “streak appeared”, “dot appeared”, “front and back misalignment”, “uneven solid”, “toner spilled”, “sheet curled”, and the like. In a case where the printing suspension details are related to color (cyan, magenta, yellow, or black), the printing suspension details may be managed by color.

The cause is the cause of the occurrence of the image error indicated by the printing suspension details. Examples of the cause of the printing suspension details include “dirty charging electrode”, “dirty roller”, “scratched drum”, “transfer failure”, “deteriorated developing device”, “high humidity”, and “dryness”. In a case where the printing suspension details are related to color, the cause may be managed by color.

The measure is the measure took by the operator against the image error indicated by the printing suspension details. Examples of the measure against the printing suspension details include “charging electrode replacement”, “drum replacement”, “transfer belt replacement”, “developing device replacement”, and “roller cleaning”. In a case where the printing suspension details are related to color, the measure may be managed by color.

The user ID is a user ID of the operator who ordered printing suspension, namely, who instructed the printer 10 to suspend printing.

The machine ID is identification information of the printer 10 instructed to suspend printing. Note that the storage section 17 stores the machine ID of the own apparatus (printer 10).

When an operator instructs a printer 10 to suspend printing, the controller 11 stores a printing suspension event indicating the printing suspension in the storage section 17 as a log. Specifically, the controller 11 stores the job ID, the start time, the cancellation time, the user ID, the machine ID, and the like in the log management table 173 in association with each other.

The printing suspension is ordered by an operator when an error related to an image printed by a printer 10 occurs.

The controller 11 allows the operator to input printing suspension details for a printing suspension event. The controller 11 allows the operator to input printing suspension details from the operation panel 14 of the printer 10. Specifically, the controller 11 causes the operation panel 14 to display, on the display part 141, a screen to input printing suspension details, and prompts the operator to input printing suspension details. The controller 11 receives the printing suspension details input by the operator via the operation part 142 of the operation panel 14. The controller 11 stores, in the log management table 173, the printing suspension details input from the operation part 142 in association with the corresponding printing suspension event. That is, the controller 11 adds the printing suspension details to a record specified by the job ID, the start time, and the like in the log management table 173.

The controller 11 allows the operator to input the cause of the printing suspension details for the printing suspension event. Specifically, the controller 11 causes the operation panel 14 to display, on the display part 141, a screen to input the cause of the printing suspension details, and prompts the operator to input the cause of the printing suspension details. The controller 11 receives the cause of the printing suspension details input by the operator via the operation part 142 of the operation panel 14. The controller 11 stores, in the log management table 173, the cause of the printing suspension details input from the operation part 142 in association with the corresponding printing suspension event.

The controller 11 allows the operator to input the measure against the printing suspension details for the printing suspension event. Specifically, the controller 11 allows the display part 141 of the operation panel 14 to display a screen to input the measure against the printing suspension details, and prompts the operator to input the measure against the printing suspension event. The controller 11 receives the measure against the printing suspension details input by the operator via the operation part 142 of the operation panel 14. The controller 11 stores, in the log management table 173, the measure against the printing suspension details input from the operation part 142 in association with the corresponding printing suspension event.

When an operator instructs a printer 10 to suspend printing, the controller 11 stores identification information (user ID) of the operator, who ordered the printing suspension, in the storage section 17 in association with the printing suspension event. The controller 11 stores the user ID of the operator in the corresponding record in the log management table 173.

The controller 11 stores the time at which the printing suspension was ordered by the operator in the storage section 17 as a printing suspension start time. Specifically, when printing suspension is ordered by the operator, the controller 11 obtains the current time from the time measurement section 16. The controller 11 stores the current time (printing suspension start time) in the corresponding record in the log management table 173.

The controller 11 stores the time at which the operator instructed the printer 10 to resume printing in the storage section 17 as a printing suspension cancellation time. Specifically, when printing resumption is ordered by the operator, the controller 11 obtains the current time from the time measurement section 16. The controller 11 stores the current time (printing suspension cancellation time) in the corresponding record in the log management table 173.

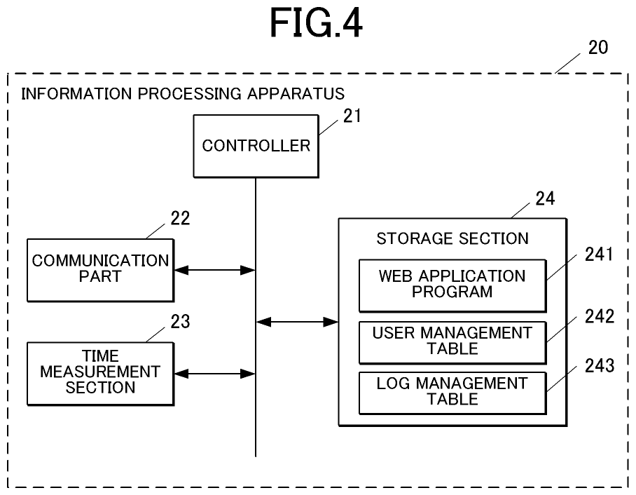

FIG. 4 is a block diagram illustrating a functional configuration of the information processing apparatus 20. As illustrated in FIG. 4, the information processing apparatus 20 includes a controller 21 (hardware processor), a communication part 22, a time measurement section 23, and a storage section 24 (storage). The components constituting the information processing apparatus 20 are connected by a bus.

The controller 21 includes a CPU and a RAM. The controller 21 comprehensively controls the operation of each component of the information processing apparatus 20. Specifically, the CPU reads various programs stored in the storage section 24, and loads the read programs to the RAM. The CPU performs various kinds of processing in cooperation with the programs.

The communication part 22 includes a network interface and the like. The communication part 22 performs data transmission and reception with an external apparatus connected via the communication networks N1 and N2.

The time measurement section 23 includes a time measurement circuit. The time measurement section 23 measures the current date and time with the time measurement circuit, and outputs the current date and time to the controller 21.

The storage section 24 is constituted by an HDD, an SSD, a nonvolatile semiconductor memory, or the like. The storage section 24 stores various programs, various data necessary for executing the programs, and the like. For example, the storage section 24 stores a web application program 241, a user management table 242, a log management table 243, and the like.

The web application program 241 is a program for collecting log data from each printer 10 and analyzing the collected log data. The web application program 241 is a program for providing various screens to the display apparatus 30 via a web browser.

The user management table 242 is a table for managing users who use the information processing system 100. In the user management table 242, a user ID, a password, and the like are associated with each user. Note that the user management table 242 includes users who use the printers 10.

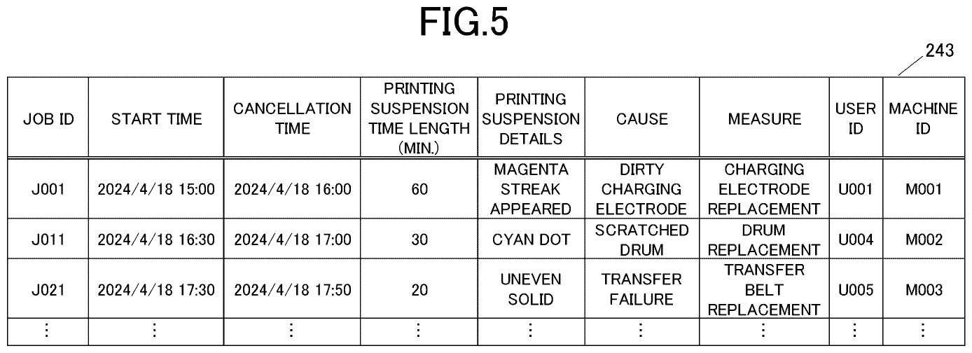

The log management table 243 is a table for managing logs of printing suspension based on manual operation instructions collected from the printers 10. FIG. 5 illustrates an example of the data structure of the log management table 243. In the log management table 243, for each printing suspension event, a job ID, a start time, a cancellation time, a printing suspension time length, printing suspension details, a cause, a measure, a user ID, and a machine ID are associated.

The job ID, the start time, the cancellation time, the printing suspension details, the cause, the measure, the user ID, and the machine ID are the same as those of the log management table 173 (see FIG. 3), and thus the descriptions thereof will be omitted.

The printing suspension time length is a length of time during which printing was suspended. That is, the printing suspension time length is a length of time from the start of printing suspension to cancellation of the printing suspension.

The controller 21 stores the log data obtained from each printer 10 in the storage section 24. Specifically, the controller 21 associates and stores a job ID, a start time, a cancellation time, printing suspension details, a cause, a measure, a user ID, and a machine ID with each printing suspension event in the log management table 243. That is, the controller 21 stores the log data obtained from each printer 10 in the log management table 243 in a state in which the correspondence relationship is maintained. Therefore, when each operator instructs each printer 10 to suspend printing, each printing suspension event indicating the printing suspension is stored as a log in the storage section 24 by the controller 11 of each printer 10 and the controller 21 of the information processing apparatus 20.

The controller 21 causes the display apparatus 30 to display the printing suspension details input in the printer 10 and the printing suspension time length in the printing suspension event.

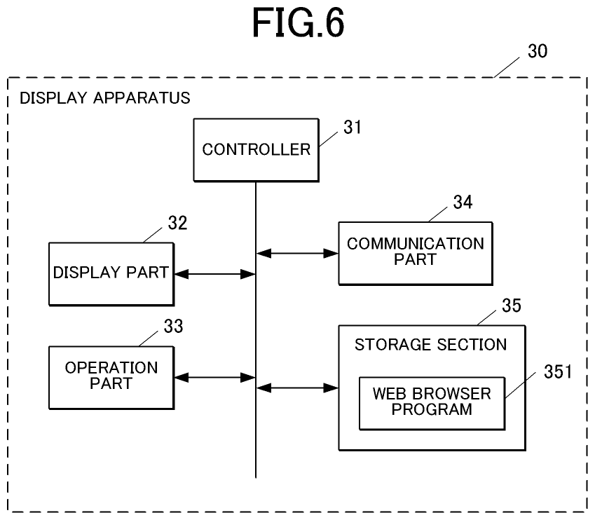

FIG. 6 is a block diagram illustrating a functional configuration of the display apparatus 30. As illustrated in FIG. 6, the display apparatus 30 includes a controller 31, a display part 32, an operation part 33, a communication part 34, and a storage section 35. The components constituting the display apparatus 30 are connected by a bus.

The controller 31 includes a CPU and a RAM. The controller 31 comprehensively controls the operation of each component of the display apparatus 30. Specifically, the CPU reads various programs stored in the storage section 35, and loads the read programs to the RAM. The CPU performs various kinds of processing in cooperation with the programs.

The display part 32 is constituted by an LCD or the like. The display part 32 displays various screens in accordance with instructions of display signals input from the controller 31.

The operation part 33 receives an operation input by a user. The operation part 33 outputs, to the controller 31, an operation signal based on the user operation. The operation part 33 includes a keyboard, a mouse, a touch screen, and the like.

The communication part 34 includes a network interface and the like. The communication part 34 performs data transmission and reception with an external apparatus connected via the communication network N2.

The storage section 35 is constituted by an HDD, an SSD, a nonvolatile semiconductor memory, or the like. The storage section 35 stores various programs, various types of data required for executing the programs, and the like. For example, the storage section 35 stores a web browser program 351 and the like.

The web browser program 351 is a program for implementing a web browser.

Next, operation of the information processing system 100 will be described.

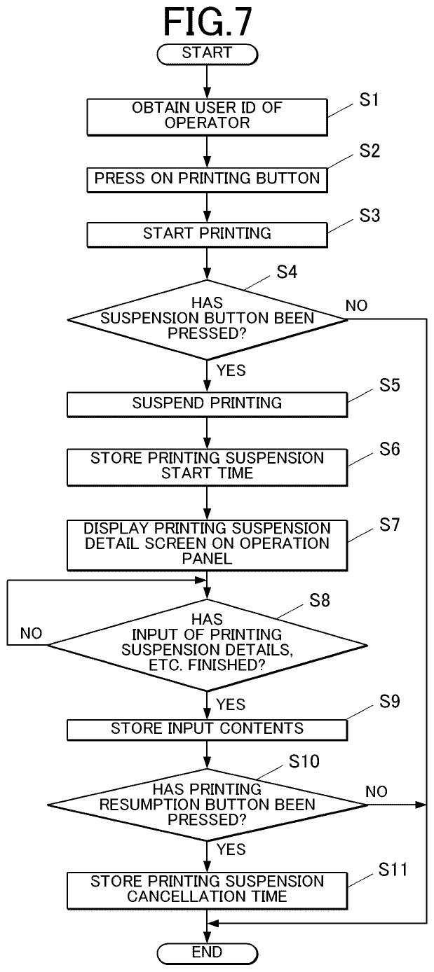

FIG. 7 is a flowchart illustrating a first manual suspension recording process that is performed in the printer 10. The first manual suspension recording process is realized by software processing by the CPU of the controller 11 working together with the manual suspension recording program 171 stored in the storage section 17.

First, the controller 11 obtains a user ID of an operator who operates the printer 10 (Step S1). For example, the controller 11 causes the display part 141 to display a login screen. The controller 11 receives a user ID and a password input by operations on the operation part 142. When a record matching the combination of the user ID and the password exists in the user management table 172, the controller 11 permits login to the printer 10. In a case where the printer 10 includes a card reader for IC cards, the controller 11 may obtain, from an IC card carried by the operator via the card reader, the user ID of the operator stored in the IC card.

Next, the controller 11 detects a press on a printing button by an operator operation on the operation part 142 (Step S2). The printing button may be a hard key or a soft key. When the printing button is pressed, the controller 11 controls the printing section 12 and the like to start printing (Step S3).

Next, the controller 11 determines whether a suspension button has been pressed by an operator operation on the operation part 142 (Step S4). The suspension button may be a hard key or a soft key. A press on the suspend button corresponds to an instruction to suspend printing.

If the suspend button has been pressed (Step S4; YES), the controller 11 controls the printing section 12 and the like to suspend printing (Step S5). The controller 11 obtains the time at which the printing suspension was ordered by the operator, from the time measurement section 16. The controller 11 stores the obtained time as the printing suspension start time in the storage section 17 (Step S6). Specifically, the controller 11 associates the job ID, the start time, the user ID, and the machine ID with each other and stores the same in the log management table 173 as a new record of a printing suspension event. Here, the job ID is the job ID of the job that was being performed when the printing suspension was ordered by the operator. The user ID is the user ID obtained in Step S1. The machine ID is the machine ID of the own apparatus (printer 10) stored in the storage section 17.

Next, the controller 11 causes the operation panel 14 (display part 141) to display a printing suspension detail input screen (Step S7).

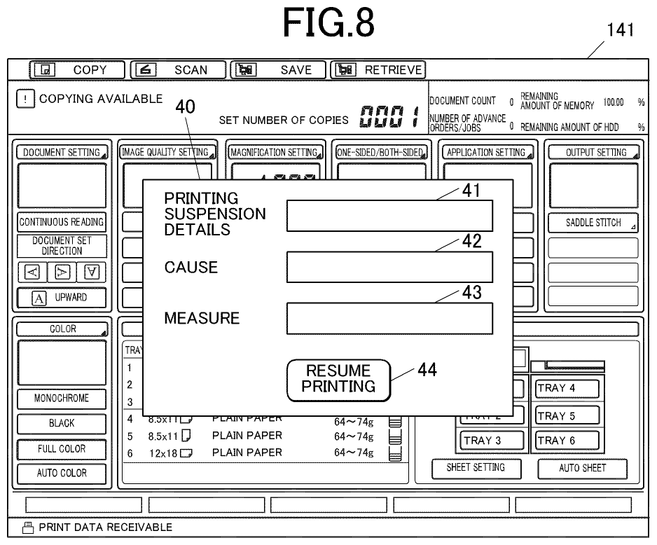

FIG. 8 illustrates an example of a printing suspension detail input screen 40 displayed on the display part 141. The printing suspension detail input screen 40 includes a printing suspension detail input area 41, a cause input area 42, a measure input area 43, a printing resumption button 44, and the like.

The printing suspension detail input area 41 is an area for the operator to input printing suspension details.

The cause input area 42 is an area for the operator to input the cause of the printing suspension details.

The measure input area 43 is an area for the operator to input the measure against the printing suspension details.

The printing resumption button 44 is a button for the operator to order printing resumption.

The controller 11 receives the printing suspension details, the cause and the measure input by the operator via the operation part 142 of the operation panel 14. The operator may be allowed to freely input the printing suspension details, the cause, and the measure in text (sentence). Alternatively, the operator may select the printing suspension details, the cause, and the measure from a plurality of candidates prepared in advance.

Here, the controller 11 determines whether the input of the printing suspension details, the cause and the measure by the operator has finished (Step S8). If the controller 11 determines that the input of the printing suspension details, the cause and the measure by the operator has not finished (Step S8; NO), the process returns to Step S8.

In Step S8, if the controller 11 determines that the input of the printing suspension details, the cause and the measure by the operator has finished (Step S8; YES), the controller 11 stores the input contents in the storage section 17 (Step S9). Specifically, the controller 11 stores the input printing suspension details, cause and measure in the log management table 173 in association with the corresponding printing suspension event. That is, the controller 11 adds the printing suspension details, the cause and the measure to the new record added to the log management table 173 in Step S6.

Next, the controller 11 determines whether the printing resumption button 44 has been pressed by an operator operation on the operation part 142 (Step S10). A press on the printing resumption button 44 corresponds to an instruction to resume printing. FIG. 8 illustrates an example in which the printing resumption button 44 is a soft key. Alternatively, the printing button that is a hard key may also function as the printing resumption button.

If the controller 11 determines that the printing resumption button has been pressed (Step S10; YES), the controller 11 obtains, from the time measurement section 16, the time at which the printing resumption was ordered by the operator. The controller 11 stores the obtained time as the printing suspension cancellation time in the storage section 17 (Step S11). Specifically, the controller 11 stores the cancellation time in the log management table 173 in association with the corresponding printing suspension event. That is, the controller 11 adds the cancellation time to the new record added to the log management table 173 in Step S6.

After Step S11, after the controller 11 determines that the suspension button has not been pressed in Step S4 (Step S4; NO), or after the controller 11 determines that the printing resumption button has not been pressed in Step S10 (Step S10; NO), the first manual suspension recording process ends.

In some cases, the operator may turn off the power of the printer 10 after ordering printing suspension. When the power of the printer 10 is turned on again, if the printing suspension details, the cause and the measure are not input in the log management table 173, the controller 11 restarts the process from Step S7.

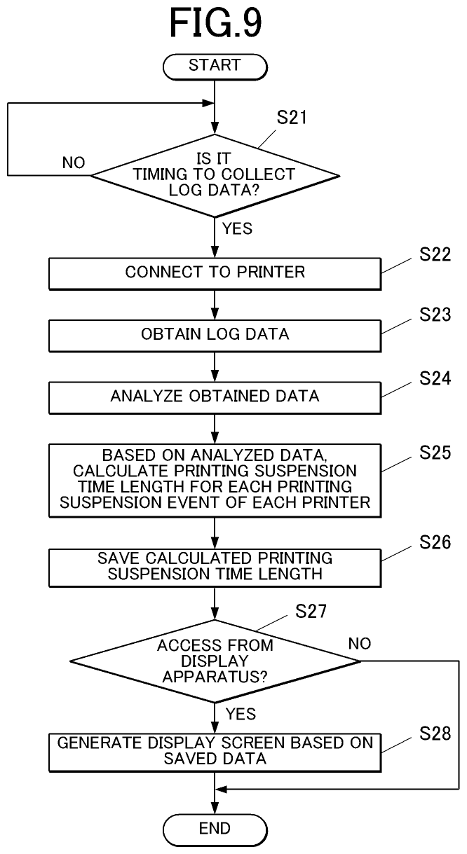

FIG. 9 is a flowchart illustrating a first printing suspension information management process that is performed in the information processing apparatus 20. The first printing suspension information management process is realized by software processing by the CPU of the controller 21 working together with the web application program 241 stored in the storage section 24.

First, the controller 21 obtains the current date and time from the time measurement section 23. The controller 21 determines whether the current date and time is a preset timing to collect log data (Step S21). For example, the information processing apparatus 20 is set to collect data from each printer 10 at the same time every day. If the current date and time is not the timing to collect log data (Step S21; NO), the process returns to Step S21.

In Step S21, if the current date and time is the timing to collect log data (Step S21; YES), the controller 21 connects to each printer 10 via the communication part 22 (Step S22). The controller 21 obtains log data from each printer 10 via the communication part 22 (Step S23). Specifically, the controller 21 obtains, from each printer 10, the job ID, the start time, the cancellation time, the printing suspension details, the cause, the measure, the user ID, and the machine ID for each printing suspension event. The controller 21 need only obtain the data accumulated in each printer 10 from the last time the controller 21 obtained log data until now. The controller 21 stores the log data obtained from each printer 10 in the log management table 243 of the storage section 24.

Next, the controller 21 analyzes the obtained date (Step S24).

Based on the analyzed data, the controller 21 calculates the printing suspension time length for each printing suspension event of each printer 10 (Step S25). Specifically, for each printing suspension event added to the log management table 243, the controller 21 calculates the printing suspension time length based on the start time and the cancellation time.

Next, the controller 21 saves the calculated printing suspension time length in the storage section 24 (Step S26). Specifically, the controller 21 stores the printing suspension time length in the log management table 243 in association with the corresponding printing suspension event.

Next, the controller 21 determines whether there has been access from the display apparatus 30 (Step S27). For example, the controller 21 obtains a user ID and a password input in the display apparatus 30 via the communication part 22. When a record matching the combination of the user ID and the password exists in the user management table 242, the controller 21 permits login in the display apparatus 30.

If there has been access from the display apparatus 30 (Step S27; YES), the process proceeds to Step S28. In Step S28, the controller 21 generates a display screen based on the date saved in the storage section 24 (log management table 243). The controller 21 causes the display apparatus 30 to display a screen related to manual suspension on the display part 32 on the basis of the generated display screen data.

After Step S28 or after the controller 21 determines that there has been no access from the display apparatus 30 in Step S27 (Step S27; NO), the first printing suspension information management process ends.

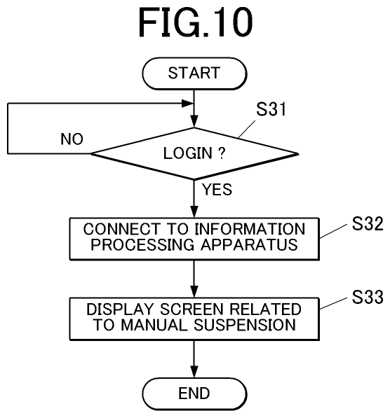

FIG. 10 is a flowchart illustrating a first printing suspension information browsing process that is performed in the display apparatus 30. The first printing suspension information browsing process is realized by software processing by the CPU of the controller 31 working together with the web browser program 351 stored in the storage section 35.

First, the controller 31 determines whether login to the information processing apparatus 20 has been performed from the web browser (Step S31). In the display apparatus 30, an operator who operates the display apparatus 30 inputs his/her user ID and password from the operation part 33. If no login to the information processing apparatus 20 has been performed (Step S31; NO), the process returns to Step S31.

If the controller 31 determines that login to the information processing apparatus 20 has been performed in Step S31 (Step S31; YES), the controller 31 connects to the information processing apparatus 20 via the communication part 34 (Step S32).

Next, the controller 31 causes the display part 32 to display a screen related to manual suspension on the basis of the display screen data provided by the information processing apparatus 20 (Step S33).

Then, the first printing suspension information browsing process ends.

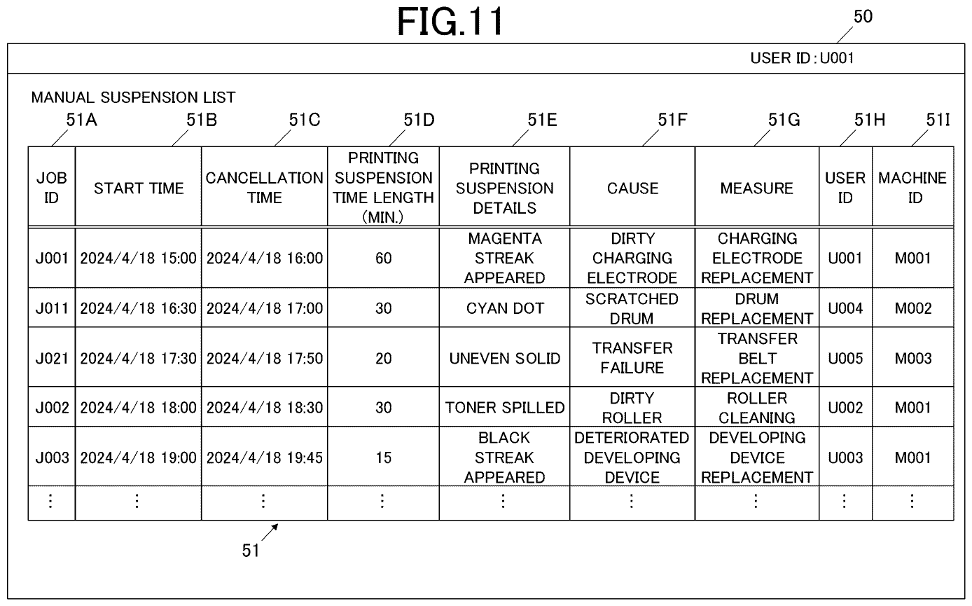

FIG. 11 illustrates an example of a manual suspension log display screen 50 that is displayed on the display part 32 of the display apparatus 30. The manual suspension log display screen 50 includes a log data display area 51. The log data display area 51 is provided with a job ID field 51A, a start time field 51B, a cancellation time field 51C, a printing suspension time length field 51D, a printing suspension detail field 51E, a cause field 51F, a measure field 51G, a user ID field 51H, and a machine ID field 51I. In the fields 51A to 51I in the log data display area 51, for each printing suspension event, the data stored in the log management table 243 are displayed.

Note that the operator of the display apparatus 30 may be able to specify a period, a printer (machine ID), an operator (user ID), and the like to be displayed, with operations on the operation part 33. In this case, the controller 21 of the information processing apparatus 20 narrows down the log data to be displayed on the display part 32 of the display apparatus 30 in accordance with the conditions such as the specified period, printer, and operator.

As described above, according to the first embodiment, when an operator instructs a printer 10 to suspend printing, the controller 11 of the printer 10 stores a printing suspension event indicating the printing suspension in the storage section 17 as a log. The controller 11 allows the operator to input printing suspension details for the printing suspension event. The controller 11 of the printer 10 and the controller 21 of the information processing apparatus 20 can leave a record of the printing suspension details. The controller 21 causes the display apparatus 30 to display the printing suspension details input in the printer 10 and the printing suspension time length in the printing suspension event. Therefore, the controller 21 can provide information on the printing suspension ordered manually. The user can use the printing suspension details and the printing suspension time length for analysis of or measures against printing suspension.

The controller 11 of the printer 10 allows the operator to input the cause of the printing suspension details for the printing suspension event. Accordingly, the controller 11 of the printer 10 and the controller 21 of the information processing apparatus 20 can leave a record of the cause of the printing suspension details.

The controller 11 of the printer 10 allows the operator to input the measure against the printing suspension details for the printing suspension event. Accordingly, the controller 11 of the printer 10 and the controller 21 of the information processing apparatus 20 can leave a record of the measure against the printing suspension details.

The controller 11 of the printer 10 allows the operator to input printing suspension details from the operation panel 14 of the printer 10. Therefore, the controller 11 can immediately request the operator who ordered printing suspension to input printing suspension details.

The controller 11 of the printer 10 can store the time at which printing suspension was ordered by the operator in the storage section 17 as the printing suspension start time.

The controller 11 of the printer 10 can also store the time at which printing resumption was ordered by the operator in the storage section 17 as the printing suspension cancellation time.

The operator checks with his/her eyes an image printed by the printer 10, and if he/she finds an error related to the image, the/she instructs the printer 10 to suspend printing. The controller 11 of the printer 10 and the controller 21 of the information processing apparatus 20 can leave a record of the error related to the image.

### Second Embodiment

Next, a second embodiment to which the present invention is applied will be described.

Regarding the information processing system of the second embodiment, the same components as those of the information processing system 100 (see FIG. 1, FIG. 2, FIG. 4, and FIG. 6) described in the first embodiment are denoted by the same reference signs, and the illustrations and descriptions of the components will be omitted. Hereinafter, components and processes characteristic of the second embodiment will be described.

In the second embodiment, when each operator instructs each printer 10 to suspend printing, the start time and the cancellation time are recorded in each printer 10. Meanwhile, the printing suspension details, the cause and the measure are not recorded in each printer 10, but are input later in the display apparatus 30.

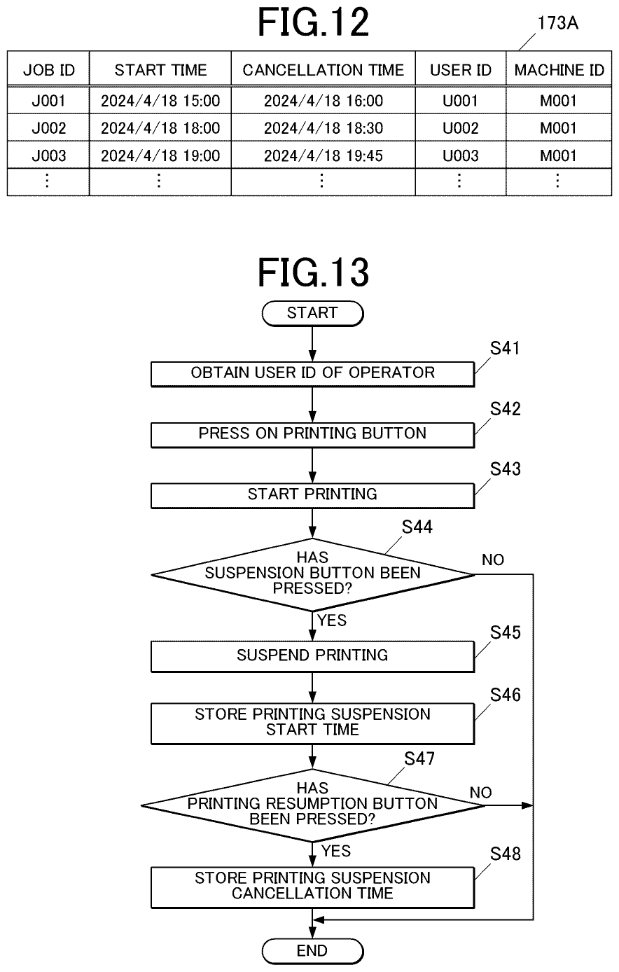

In the storage section 17 of the printer 10, a log management table 173A illustrated in FIG. 12 is stored instead of the log management table 173 (see FIG. 3).

The log management table 173A is a table for managing logs of printing suspension based on manual operation instructions generated in the printer 10. In the log management table 173A, for each printing suspension event, a job ID, a start time, a cancellation time, a user ID, and a machine ID are associated.

When an operator instructs a printer 10 to suspend printing, the controller 11 of the printer 10 stores a printing suspension event indicating the printing suspension as a log in the storage section 17. Specifically, the controller 11 stores the job ID, the start time, the cancellation time, the user ID, the machine ID, and the like in the log management table 173A in association with each other.

When an operator instructs a printer 10 to suspend printing, the controller 11 stores identification information (user ID) of the operator, who ordered the printing suspension, in the storage section 17 in association with the printing suspension event. The controller 11 stores the user ID of the operator in the corresponding record in the log management table 173A.

The controller 21 of the information processing apparatus 20 obtains, from the printer 10, the printing suspension event indicating the printing suspension that the operator instructed the printer 10 to perform, as a log.

The controller 21 stores the log data obtained from each printer 10 in the storage section 24. Specifically, the controller 21 stores, in the log management table 243 (see FIG. 5), for each printing suspension event, the job ID, the start time, the cancellation time, the user ID, and the machine ID in association with each other. That is, the controller 21 stores the log data obtained from each printer 10 in the log management table 243 in a state in which the correspondence relationship is maintained. Therefore, when each operator instructs each printer 10 to suspend printing, each printing suspension event indicating the printing suspension is stored as a log in the storage section 24 by the controller 11 of each printer 10 and the controller 21 of the information processing apparatus 20.

The controller 21 allows the operator to input printing suspension details for the printing suspension event. The controller 21 allows the operator to input printing suspension details from the display apparatus 30. Specifically, the controller 21 allows the display apparatus 30 to display, on the display part 32, a screen to input printing suspension details, and prompts the operator to input printing suspension details. The controller 21 receives the printing suspension details input by the operator via the operation part 33 of the display apparatus 30. The controller 21 stores the printing suspension details input from the operation part 33 in the log management table 243 in association with the corresponding printing suspension event.

Specifically, the controller 21 extracts, from among printing suspension events stored in the storage section 24, a printing suspension event for which no printing suspension details have been input. The controller 21 causes the display apparatus 30 to display the extracted printing suspension event. The controller 21 allows the operator to input printing suspension details for the displayed printing suspension event.

Furthermore, the controller 21 obtains identification information (user ID) of the operator who operates the display apparatus 30.

The controller 21 extracts, from among the printing suspension events stored in the storage section 24, a printing suspension event that is associated with the user ID of the operator who operates the display apparatus 30 and for which no printing suspension details have been input. The controller 21 causes the display apparatus 30 to display the extracted printing suspension event.

The controller 21 allows the operator to input the cause of the printing suspension details for the printing suspension event. Specifically, the controller 21 causes the display apparatus 30 to display, on the display part 32, a screen to input the cause of the printing suspension details, and prompts the operator to input the cause of the printing suspension details. The controller 21 receives the cause of the printing suspension details input by the operator via the operation part 33 of the display apparatus 30. The controller 21 stores the cause of the printing suspension details input from the operation part 33 in the log management table 243 in association with the corresponding printing suspension event.

The controller 21 allows the operator to input the measure against the printing suspension details for the printing suspension event. Specifically, the controller 21 causes the display apparatus 30 to display, on the display part 32, a screen to input the measure against the printing suspension details, and prompts the operator to input the measure against the printing suspension details. The controller 21 receives the measure against the printing suspension details input by the operator via the operation part 33 of the display apparatus 30. The controller 21 stores, in the log management table 243, the measure against the printing suspension details input from the operation part 33 in association with the corresponding printing suspension event.

The controller 21 causes the display apparatus 30 to display the printing suspension details input in the display apparatus 30 and the printing suspension time length in the printing suspension event.

Next, operation of the information processing system according to the second embodiment will be described.

FIG. 13 is a flowchart illustrating a second manual suspension recording process that is performed in the printer 10. The second manual suspension recording process is realized by software processing by the CPU of the controller 11 working together with the manual suspension recording program 171 stored in the storage section 17.

Since the processes in Step S41 to Step S46 are the same as or similar to those in Step S1 to Step S6 of the first manual suspension recording process (see FIG. 7), the descriptions thereof will be omitted.

Since the processes in Step S47 and Step S48 are the same as or similar to those in Step S10 and Step S11 of the first manual suspension recording process (see FIG. 7), the descriptions thereof will be omitted.

In Steps S46 and S48, the controller 11 stores the job ID, the start time, the cancellation time, the user ID, and the machine ID in the log management table 173A in association with each other as a new record of the printing suspension event.

After Step S48, after the controller 11 determines that the suspension button has not been pressed in Step S44 (Step S44; NO), or after the controller 11 determines that the printing resumption button has not been pressed in Step S47 (Step S47; NO), the second manual suspension recording process ends.

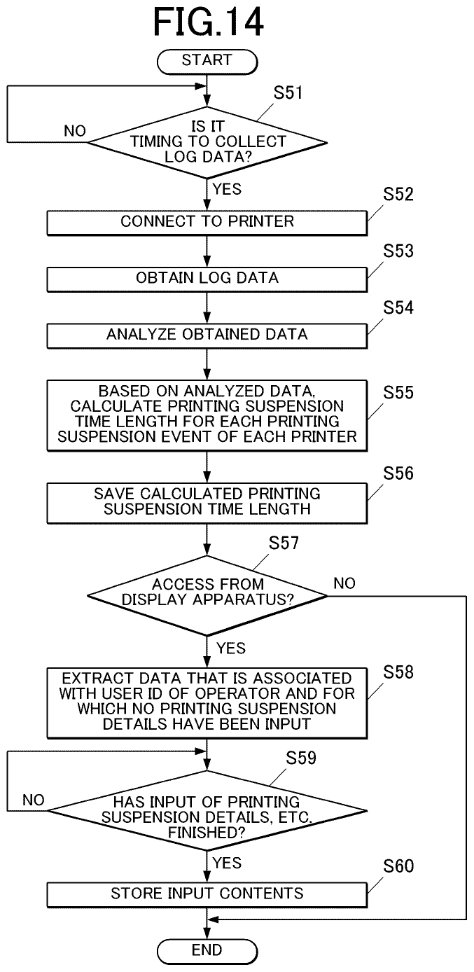

FIG. 14 is a flowchart illustrating a second printing suspension information management process that is performed in the information processing apparatus 20. The second printing suspension information management process is realized by software processing by the CPU of the controller 21 working together with the web application program 241 stored in the storage section 24.

Since the processes in Step S51 to Step S57 are the same as or similar to the processes in Step S21 to Step S27 of the first printing suspension information management process (see FIG. 9), the descriptions thereof will be omitted.

In Step S53, however, the controller 21 obtains, from each printer 10, a job ID, a start time, a cancellation time, a user ID, and a machine ID for each printing suspension event. The controller 21 stores the log data obtained from each printer 10 in the log management table 243 of the storage section 24. In Step S53, the printing suspension time length filed, the printing suspension detail field, the cause field, and the measure field for the log data obtained from each printer 10 are blank in the log management table 243.

In Step S57, if the controller 21 determines that there has been access from the display apparatus 30 (Step S57; YES), the process proceeds to Step S58. In Step S58, the controller 21 extracts, from among the data saved in the log management table 243, data that is associated with the user ID of the operator who is operating the display apparatus 30 and for which no printing suspension details have been input. The controller 21 generates a display screen based on the extracted data. The controller 21 causes the display apparatus 30 to display a screen related to manual suspension on the display part 32 on the basis of the generated display screen data.

The controller 21 receives the printing suspension details, the cause, and the measure input by the operator via the operation part 33 of the display apparatus 30.

Here, the controller 21 determines whether the input of the printing suspension details, the cause, and the measure by the operator of the display apparatus 30 has finished (Step S59). If the input of the printing suspension details, the cause, and the measure by the operator has not finished (Step S59; NO), the process returns to Step S59.

In Step S59, if the controller 21 determines that the input of the printing suspension details, the cause, and the measure by the operator has finished (Step S59; YES), the controller 21 stores the input contents in the storage section 24 (Step S60). Specifically, the controller 21 stores the input printing suspension details, cause, and measure in the log management table 243 in association with the corresponding printing suspension event.

After Step S60 or after the controller 21 determines that there has been no access from the display apparatus 30 in Step S57 (Step S57; NO), the second printing suspension information management process ends.

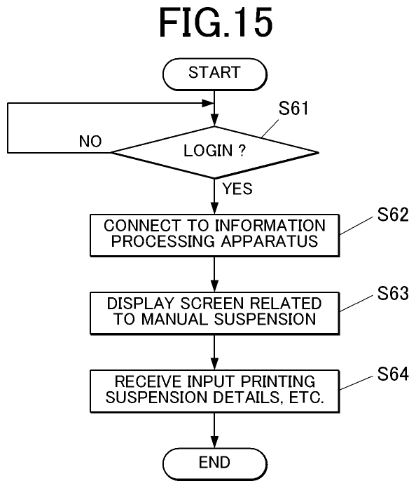

FIG. 15 is a flowchart illustrating a second printing suspension information browsing process that is performed in the display apparatus 30. The second printing suspension information browsing process is realized by software processing by the CPU of the controller 31 working together with the web browser program 351 stored in the storage section 35.

Since the processes in Step S61 to Step S63 are the same as or similar to the processes in Step S31 to Step S33 of the first printing suspension information browsing process (see FIG. 10), and the descriptions thereof will be omitted. However, on the screen displayed in Step S63, a printing suspension event(s) the printing suspension of which has been ordered by the operator who is operating the display apparatus 30 and for which no printing suspension details have been input is displayed.

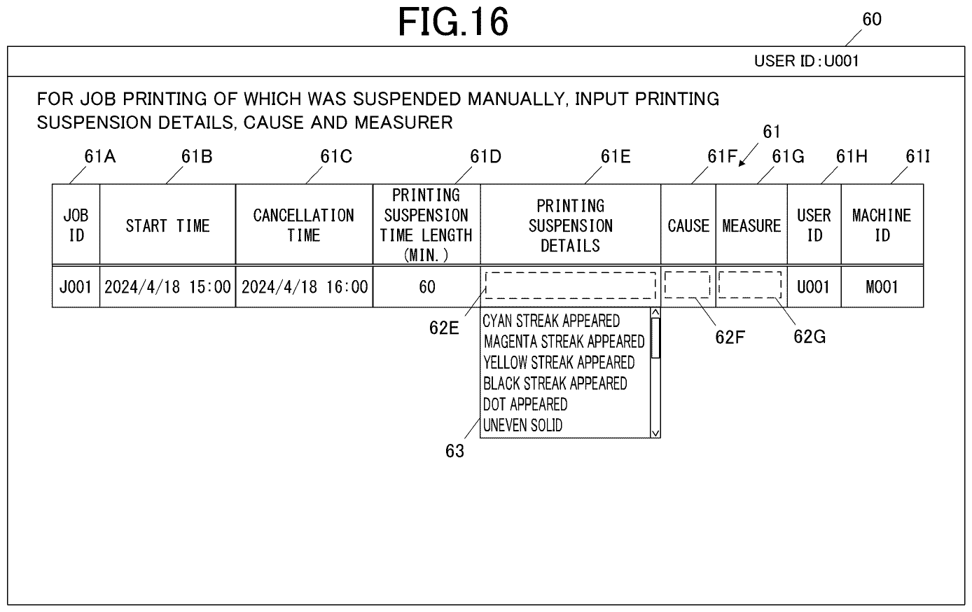

FIG. 16 illustrates an example of a manual suspension log display screen 60 displayed on the display part 32 of the display apparatus 30. The manual suspension log display screen 60 includes a log data display area 61. The log data display area 61 is provided with a job ID field 61A, a start time field 61B, a cancellation time field 61C, a printing suspension time length field 61D, a printing suspension detail field 61E, a cause field 61F, a measure field 61G, a user ID field 61H, and a machine ID field 61I. In the log data display area 61, a printing suspension event about which the operator of the display apparatus 30 has instructed the printer 10 to suspend printing and for which no printing suspension details have been input is displayed. The printing suspension detail field 61E, the cause field 61F, and the measure field 61G are blank until printing suspension details, a cause, and a measure are input by the operator operating the display apparatus 30. The manual suspension log display screen 60 also serves as a screen to input printing suspension details, a cause, and a measure.

After Step S63, the controller 31 receives the printing suspension details, the cause, and the measure input by the operator (Step S64).

The operator of the display apparatus 30 selects an input target item (printing suspension details, cause, or measure) of the printing suspension event in the log data display region 61 of the manual suspension log display screen 60 displayed on the display part 32 by operating the operation part 33. For example, when the operator clicks the printing suspension detail input area 62E, the controller 21 of the information processing apparatus 20 causes the display apparatus 30 to display a plurality of options on the display part 32 as a pull-down menu 63. When the operator selects printing suspension details from among the plurality of options, the controller 21 of the information processing apparatus 20 obtains information on the selected printing suspension details. Thereafter, in the manual suspension log display screen 60, the printing suspension details selected by the operator are displayed in the printing suspension detail input area 62E. That is, the controller 21 of the information processing apparatus 20 causes the display apparatus 30 to display the printing suspension details input in the display apparatus 30 and the printing suspension time length in the printing suspension event. The same applies to the cause input area 62F and the measure input area 62G.

Thus, the second printing suspension information browsing process ends.

In the second embodiment too, as in the first embodiment, regardless of who the operator of the display apparatus 30 is, a list of printing suspension events the printing suspension of which has been manually ordered may be displayable (see FIG. 11).

As described above, according to the second embodiment, when an operator instructs a printer 10 to suspend printing, the controller 11 of the printer 10 stores a printing suspension event indicating the printing suspension in the storage section 17 as a log. The controller 21 of the information processing apparatus 20 obtains, from the printer 10, the printing suspension event indicating the printing suspension that the operator instructed the printer 10 to perform, as a log. The controller 21 allows the operator to input printing suspension details for the printing suspension event. The controller 21 can leave a record of the printing suspension details. The controller 21 causes the display apparatus 30 to display the input printing suspension details and the printing suspension time length in the printing suspension event. Therefore, the controller 21 can provide information on the printing suspension ordered manually.

The controller 21 of the information processing apparatus 20 allows the operator to input the cause of the printing suspension details for the printing suspension event. Thus, the controller 21 can leave a record of the cause of the printing suspension details.

The controller 21 of the information processing apparatus 20 allows the operator to input the measure against the printing suspension details for the printing suspension event. Thus, the controller 21 can leave a record of the measure against the printing suspension details.

The controller 21 of the information processing apparatus 20 allows the operator to input printing suspension details from the display apparatus 30. Therefore, the controller 21 can request the operator to input printing suspension details after printing suspension.

For example, for a printing suspension event for which no printing suspension details have been input, the controller 21 of the information processing apparatus 20 allows the operator to input printing suspension details from the display apparatus 30. Thus, the controller 21 can prompt the operator to input printing suspension details only for the printing suspension event for which no printing suspension details have been input.

Furthermore, the controller 21 of the information processing apparatus 20 allows the operator to input printing suspension details by narrowing down to a printing suspension event(s) the printing suspension of which has been ordered by the operator himself/herself, who operates the display apparatus 30. Thus, the controller 21 can request the operator who has ordered the printing suspension to input printing suspension details.

Note that the descriptions in the above embodiments are examples of the information processing system, the information processing method, the information processing apparatus, and the program according to the present invention, and the present invention is not limited to these. The detailed configuration and detailed operation of each apparatus constituting the system can also be appropriately changed without departing from the scope of the present invention.

For example, in each of the above embodiments, the operator inputs printing suspension details, the cause of the printing suspension details, and the measure against the printing suspension details. Instead of this, the operator may be requested to input at least printing suspension details, and the input of the cause of the printing suspension details and the measure against the printing suspension details may be optional.

In each of the above embodiments, the controller 21 of the information processing apparatus 20 calculates, for each printing suspension event, the printing suspension time length. Alternatively, the controller 11 of the printer 10 may calculate, for each printing suspension event, the printing suspension time length from the start time and the cancellation time of the printing suspension. In this case, the controller 21 of the information processing apparatus 20 obtains log data including the printing suspension time length from the printer 10 via the communication part 22. Furthermore, the controller 11 of the printer 10 may store, for each printing suspension event, the start time of the printing suspension and the printing suspension time length (duration of the printing suspension) in the storage section 17. In this case, the controller 21 of the information processing apparatus 20 obtains log data including the start time of the printing suspension and the printing suspension time length from the printer 10 via the communication part 22.

Furthermore, the controller 21 of the information processing apparatus 20 may automatically determine the cause of the printing suspension details on the basis of the printing suspension details input by the operator.

By analyzing the printing suspension details input by the operator, the controller 21 of the information processing apparatus 20 may classify the printing suspension event as a group among a plurality of groups.

The controller 21 of the information processing apparatus 20 may tally up printing suspension time lengths in a predetermined period, for each cause of printing suspension details.

The controller 21 of the information processing apparatus 20 may tally up the numbers of times of printing suspension in a predetermined period, for each cause of printing suspension details.

In each of the above embodiments, the operator checks, with his/her eyes, an image printed by the printer 10 and instructs the printer 10 to suspend printing when the operator finds an error related to the image. Instead of this or in addition to this, the operator may instruct the printer 10 to suspend printing, for example, when abnormal sound occurs in the printer 10 or when the temperature of the printer 10 exceeds a normal range.

The computer-readable medium that stores the program for executing each process is not limited to the above example(s). Furthermore, a carrier wave may be applied as a medium that provides data of the program via a communication line.

Although embodiments of the present invention have been described and illustrated in detail, the disclosed embodiments are made for purposes of illustration and example only and not limitation. The scope of the present invention should be interpreted by terms of the appended claims.

What is claimed is:

1. An information processing system comprising:
a printer;
a display apparatus; and
a hardware processor that
in response to an operator instructing the printer to perform printing suspension, stores a printing suspension event indicating the printing suspension in a storage as a log,
allows the operator to input a printing suspension detail for the printing suspension event, and
causes the display apparatus to display the input printing suspension detail and a printing suspension time length in the printing suspension event.

2. The information processing system according to claim 1, wherein the hardware processor further allows the operator to input a cause of the printing suspension detail.

3. The information processing system according to claim 1, wherein the hardware processor further allows the operator to input a measure against the printing suspension detail.

4. The information processing system according to claim 1, wherein the hardware processor allows the operator to input the printing suspension detail from an operation panel of the printer.

5. The information processing system according to claim 1, wherein the hardware processor allows the operator to input the printing suspension detail from the display apparatus.

6. The information processing system according to claim 5, wherein the hardware processor
extracts, from the printing suspension event stored in the storage, the printing suspension event for which no printing suspension detail has been input,
causes the display apparatus to display the extracted printing suspension event, and
allows the operator to input the printing suspension detail for the displayed printing suspension event.

7. The information processing system according to claim 6, wherein the hardware processor
associates and stores identification information on the operator who has instructed the printer to perform the printing suspension with the printing suspension event,
obtains identification information on an operator who operates the display apparatus,
extracts, from the printing suspension event stored in the storage, the printing suspension event that is associated with the obtained identification information and for which no printing suspension detail has been input, and
causes the display apparatus to display the extracted printing suspension event.

8. The information processing system according to claim 1, wherein the hardware processor stores a time at which the operator instructed the printer to perform the printing suspension in the storage as a printing suspension start time.

9. The information processing system according to claim 8, wherein the hardware processor stores a time at which the operator instructed the printer to perform printing resumption as a printing suspension cancellation time.

10. The information processing system according to claim 1, wherein the printing suspension is ordered by the operator in response to an error related to an image printed by the printer occurs.

11. An information processing apparatus comprising a hardware processor that
obtains, as a log, a printing suspension event indicating printing suspension that an operator has instructed a printer to perform, from the printer,
allows the operator to input a printing suspension detail for the printing suspension event from a display apparatus, and
causes the display apparatus to display the input printing suspension detail and a printing suspension time length in the printing suspension event.

12. A non-transitory computer-readable storage medium storing a program causing a computer to:
obtain, as a log, a printing suspension event indicating printing suspension that an operator has instructed a printer to perform, from the printer;
allow the operator to input a printing suspension detail for the printing suspension event from a display apparatus; and
cause the display apparatus to display the input printing suspension detail and a printing suspension time length in the printing suspension event.
